(19) United States
(12) Patent Application Publication
(10) Pub. No.: US 2024/0403416 A1
(43) Pub. Date: Dec. 5, 2024

(54) MACHINE LEARNING FOR EVENT MONITORING

(71) Applicant: Capital One Services, LLC, McLean, VA (US)

(72) Inventors: Samuel SHARPE, Cambridge, MA (US); Christopher Bayan BRUSS, Washington, DC (US); James O. H. MONTGOMERY, Vienna, VA (US)

(73) Assignee: Capital One Services, LLC, McLean, VA (US)

(21) Appl. No.: 18/328,709

(22) Filed: Jun. 2, 2023

(51) Int. Cl. G06F 21/55; G06F 16/242

(52) U.S. Cl. CPC G06F 21/554; G06F 16/243; G06F 2221/034

(57) ABSTRACT

In some aspects, a computing system may use a machine learning model (e.g., a large language model) with a variety of query tokens as seeds to predict probabilities of future events. The system may then use the probabilities to determine the probability of a target event based on the query tokens. The system may then sort the query tokens by probability of the target event and select the top N query tokens (e.g., the top three events for a user that are predicted to be followed by the target event). The events indicated by the query tokens may be monitored for a given time period, and, if any of those events occur, the system may generate an alert.

### SUMMARY

Event monitoring is the process of collecting, analyzing, and signaling event occurrences to operating system processes, active database rules, and others. These event occurrences may stem from software or hardware, such as operating systems, database management systems, application software, and processors. Events may be monitored by a computing system to prevent undesired effects such as cybersecurity intrusions, server downtime, machine learning model performance drift, and a variety of other effects.

With existing systems, the need for quick response and low latency can make it difficult to use machine learning to identify events that should be monitored to prevent undesired effects. In existing systems, machine learning may be used to classify an event as it occurs (e.g., in real time). However, using machine learning to classify events directly as they occur is often not fast enough for low-latency use cases. For example, performing the classification in real time may not be fast enough to prevent an undesired effect from occurring.

To address these and other issues, systems and methods described herein may use machine learning to determine what events may lead to undesired effects before the undesired effects occur. A computing system may store the determined events and if an event occurs that matches what is stored, the computing system may quickly flag the event or generate an alert without the need to perform computationally expensive machine learning tasks in real time. To achieve this, a computing system may use a machine learning model (e.g., a large language model) with a variety of query tokens as seeds to predict probabilities of future events. The system may then use the probabilities to determine the probability of a target event based on each query token. The system may then sort the query tokens by probability of the target event and select the top N query tokens (e.g., the top three events for a user that are predicted to be followed by the target event). The events indicated by the query tokens may be monitored for a given day, and if any of those events occur, the system may generate an alert. By doing so, the system can use machine learning and offline batch processing to identify the most troublesome events that can then be monitored for in a low-latency environment, without the need to classify events with machine learning on the fly.

In some aspects, a computing system may obtain a large language model trained to predict an event performed by a user, the large language model having been trained on a dataset comprising event sequences, where a second event of the event sequences indicates a probability that an earlier first event involved a malicious cybersecurity attack or other cybersecurity incident. The computing system may obtain a set of query tokens, where each query token of the set of query tokens is usable as a seed event for the large language model, and where each query token of the set of query tokens is of the same query token type. The computing system may input an event sequence and the set of query tokens into the large language model, where the event sequence is input into the large language model multiple times, each time appended with a different query token of the set of query tokens. Based on inputting the event sequence and the set of query tokens into the large language model, the computing system may generate, for each event sequence and query token pair, a set of probabilities of future events. The computing system may determine, for each query token in the set of query tokens and based on the set of probabilities of future events, a probability of a target event. The computing system may determine a first query token of the set of query tokens, where the first query token is associated with a probability of the target event that satisfies a threshold probability. Based on the first query token being associated with the probability of the target event, the computing system may mark an event associated with the first query token for monitoring.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (e.g., the entire portion), a given item (e.g., data) unless the context clearly dictates otherwise.

### BRIEF DESCRIPTION OF THE DRAWINGS

FIG. 1 shows an example diagram for a system that may use machine learning to identify events to monitor, in accordance with one or more embodiments.

FIG. 2 shows example elements that may be used in determining events to monitor, in accordance with one or more embodiments.

FIG. 3 shows illustrative components for a system that may be used to identify events for monitoring, in accordance with one or more embodiments.

FIG. 4 shows a flowchart of the steps involved in using machine learning and event sequences to determine target event probabilities, in accordance with one or more embodiments.

### DETAILED DESCRIPTION OF THE DRAWINGS

In the following description, for the purposes of explanation, numerous specific details are set forth in order to provide a thorough understanding of the embodiments of the disclosure. It will be appreciated, however, by those having skill in the art that the embodiments of the disclosure may be practiced without these specific details or with an equivalent arrangement. In other cases, well-known structures and devices are shown in block diagram form in order to avoid unnecessarily obscuring the embodiments of the disclosure.

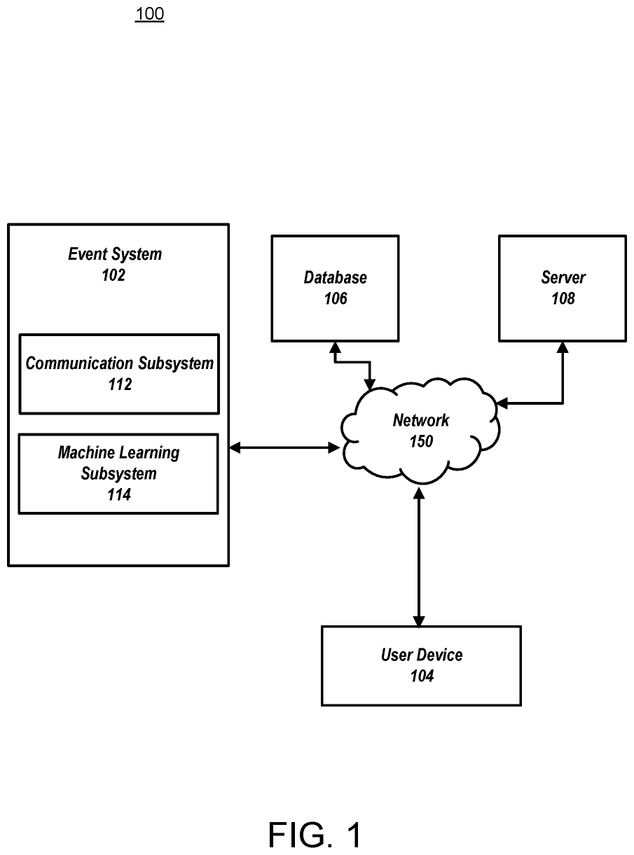

FIG. 1 shows an illustrative system 100 that may use machine learning to determine what events may lead to undesired effects before the undesired effects occur. The system 100 may store the determined events and if an event occurs that matches what is stored, the system 100 may quickly flag the event or generate an alert without the need to perform computationally expensive machine learning tasks in real time. To achieve this, the system 100 may use a machine learning model (e.g., a large language model) with a variety of query tokens as seeds to predict probabilities of future events. The system may then use the probabilities to determine the probability of a target event based on the query tokens. The system may then sort the query tokens by probability of the target event and select the top N query tokens (e.g., the top three events for a user that are predicted to be followed by the target event). The events indicated by the query tokens may be monitored for a given day (or other time period), and, if any of those events occur, the system may generate an alert. By doing so, the system can use machine learning and offline batch processing to identify the most troublesome events that can then be monitored for in a low-latency environment, without the need to classify events with machine learning on the fly.

In the context of large language models, query tokens may be individual input tokens that are fed into a model in connection with a given input. For example, large language models use tokenization to break down the input text into one or more tokens, which are usually words, phrases, or subwords, depending on the tokenization strategy employed. In one use case, when a given input is received (e.g., a user prompt, an event description, etc.), the large language model tokenizes the input and generates context vectors for each token. In one use cases, a single query token may correspond to a given event. The model then processes these tokens, taking into account their order and relationships, to understand the meaning of the input and generate an appropriate response.

The system 100 may include an event system 102, a user device 104, a database 106, and a server 108 that may communicate with each other via a network 150. The event system 102 may include a communication subsystem 112, a machine learning subsystem 114, or a variety of other components. In some embodiments, the system 100 may include additional devices or components such as one or more servers, firewalls, databases, or a variety of other computing devices or components.

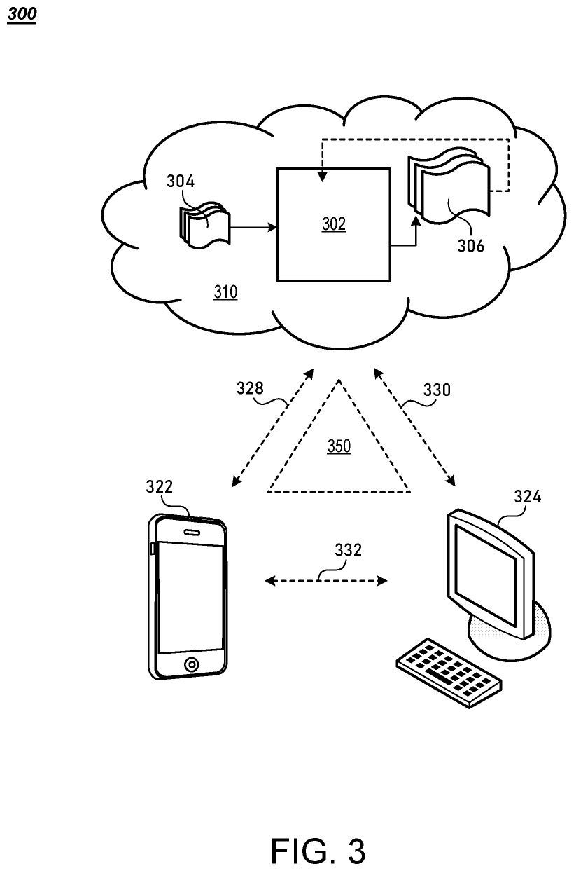

The event system 102 may obtain a machine learning model. The machine learning model may be a large language model (LLM). A large language model may include a neural network with greater than a threshold number of parameters (e.g., greater than 1 billion parameters, greater than 1 trillion parameters, etc.). The large language model may have been trained using self-supervised learning (e.g., using data stored in the database 106). Alternatively, the machine learning model may be any model described in connection with FIG. 3. The machine learning model may have been trained to predict an event performed by a user, such as a transaction (e.g., transaction at a specific merchant or merchant type), online action (click, page, view, etc.), or other event. The machine learning model may have been trained using sequences of events (e.g., events in the order that they occurred). In some embodiments, a second event of the event sequences may indicate a probability that an earlier first event involved a cybersecurity incident or one or more other activities.

The event system 102 may obtain a set of query tokens. Each query token may indicate an event. Each query token may be used as a seed event for the machine learning model. For example, the machine learning model may generate output indicating future events or probabilities of future events that may occur in connection with the event indicated by the query token. Each query token of the set of query tokens may be of the same query token or event type. For example, each query token may correspond to a transaction event.

The event system 102 may input an event sequence and one or more query tokens of the set of query tokens into a machine learning model. The event sequence may be input into the machine learning model multiple times or in batches. Each time the event sequence is input into the machine learning model, the event sequence may be appended with a different query token of the set of query tokens. This may enable the machine learning model to predict different probabilities of future events because each input will be different due to the different query tokens.

The event system 102 may generate one or more sets of probabilities of future events. The event system 102 may generate one set of probabilities for each query token or for each query token and event sequence pair. For example, a first event sequence may include events associated with a first user. The event system 102 may generate one set of probabilities for each query token and first event sequence pairing. A set of probabilities may correspond to multiple predicted future events. For example, a first vector in the set of probabilities may include probabilities for every possible event at a first time step, and a second vector in the set of probabilities may include probabilities for every possible event at a second time step.

The event system 102 may repeat this process for additional users. For example, the event system 102 may additionally generate one set of probabilities for each query token and second event sequence pairing (e.g., the second event sequence corresponding to a second user). By doing so, the event system 102 may be able to use the probabilities to determine what events should be monitored for each user, as discussed in more detail below. By determining probabilities specific to each user, the event system 102 may be able to better identify the riskiest events or actions for each user and may thus be more efficient in monitoring. This is because the event system 102 may be able to focus monitoring for a few actions for each specific user. Further, the event system 102 may determine the actions that are riskiest in an offline batch process and store the events in a lookup table or other data structure. In this way, the online process can be performed much more quickly (e.g., with low-latency of less than 200 ms) because the system may simply compare events as they occur with the events that have been stored rather than perform computationally expensive machine learning classifications live.

In some embodiments, the event system 102 may determine one or more probabilities of one or more target events. The event system 102 may use the sets of probabilities of the future events to determine a probability (e.g., an average probability) of a target event occurring. The event system 102 may determine an average probability of the target event occurring over the next threshold number of time steps or threshold number of events with which the user is associated.

The event system 102 may determine a first query token with an associated target event probability that satisfies a probability threshold. For example, the event system 102 may determine that the first query token has the highest average probability of the target event occurring, based on the sets of probabilities of future events that were generated for the first query token (e.g., when the first query token was appended onto an event sequence and input into the machine learning model).

In some embodiments, the event system 102 may cause monitoring for an event indicated by the first query token. The event system 102 may cause a monitoring system (e.g., the server 108) to monitor for the event indicated by the first query token. For example, the event indicated by the first query token may involve a transaction with a particular merchant, a late payment by the user toward paying off a credit card debt, or a variety of other events.

In some embodiments, the event system 102 may generate one or more event listeners (e.g., at one or more other data feeds) configured to listen for one or more events indicated by one or more query tokens with associated target event probabilities that satisfy a probability threshold (e.g., the first query token has the highest average probability of the target event occurring). When such events are detected via the event listeners, the event system 102 may determine one or more actions (e.g., defensive actions) to be taken. In some scenarios, the determined actions may be automatically performed without further user action subsequent to the detection, such as (i) generating and sending an alert to a user with which the target event is associated (e.g., the user being monitored), (ii) sending an alert to an administrative user (e.g., a warning of the target event, a recommendation to prevent or reduce a negative impact of the target event, etc.), (iii) escalating a notification related to the detected event or the target event, (iv) implementing one or more restrictions on an account of the user with which the target event is associated (e.g., limiting access of the account to one or more data resources of the account of the user, (v) limiting access of the account to one or more usage amount thresholds, etc.), or (vi) other actions. In this way, for example, in addition to enabling actions to quickly be taken (e.g., to prevent or reduce a negative impact of the target event), the event system 102 can perform such monitoring for a smaller subset of events, thereby reducing the number of event listeners and the related network resource usage or other computational resource usage.

In some embodiments, the event system 102 may determine a top threshold number of query tokens with the highest probability for the target event for a given user. For example, the event system 102 may sort the query tokens by average probability of the target event and select the top three query tokens. The events indicated by the top three query tokens may be monitored for. If an event indicated by one of the top three query tokens occurs, the event system 102 may generate an alert or message. The alert or message may reverse the event (e.g., if the event is a transaction or other reversible event). The alert or message may be sent to a second user so that the second user can review the event and take further action.

This process may be repeated for multiple users. For example, each user may have their own threshold number of events that are monitored due to the corresponding query tokens having a high probability (e.g., higher than a threshold) of a target event occurring.

In some embodiments, the event system 102 may generate probabilities of future events without the use of query tokens. The event system 102 may generate a set of probabilities to use for classifying one or more events. The events may be events in an event sequence that was used as input to generate the set of probabilities. The event system 102 may determine, based on the set of probabilities, that a target event has greater than a threshold probability of occurring. Based on the target event having greater than the threshold probability of occurring, the event system 102 may generate a first classification for a historical event in the event sequence.

The event system 102 may generate a set of probabilities of future events based on a first event sequence. The first event sequence may be input into a machine learning model (e.g., a large language model or a model described in connection with FIG. 3). The first event sequence may be input into the machine learning model without a query token appended. As an example, the event system 102 may determine based on the set of probabilities of future events, that a target event has greater than a threshold probability of occurring. For example, the target event may be a fraud claim made by a user (e.g., via an application). A fraud claim may indicate that one of the events in the first event sequence was a fraudulent transaction. If the machine learning model predicts future events that have a high probability (e.g., higher than a threshold) of a fraud claim, it may indicate that one of the events in the sequence was fraudulent. Thus, based on the target event of a fraud claim having greater than the threshold probability of occurring, the event system 102 may generate a classification indicating that one or more of the events in the first event sequence was a fraudulent transaction.

As an additional example, the event system 102 may use an event sequence and the machine learning model to try to predict whether a user will have a charge off within the next eighteen months. The event system 102 may use the machine learning model to generate probabilities of future events for the event sequence and may look for the target event of becoming past due on credit card payoffs. In this example, there may be a charge off if the user is past due for more than eight months in a row. If the event system 102 determines that an average probability of becoming past due on credit card payoffs is greater than the threshold probability, the event system 102 may classify one or more events in the event sequence as a charge off event.

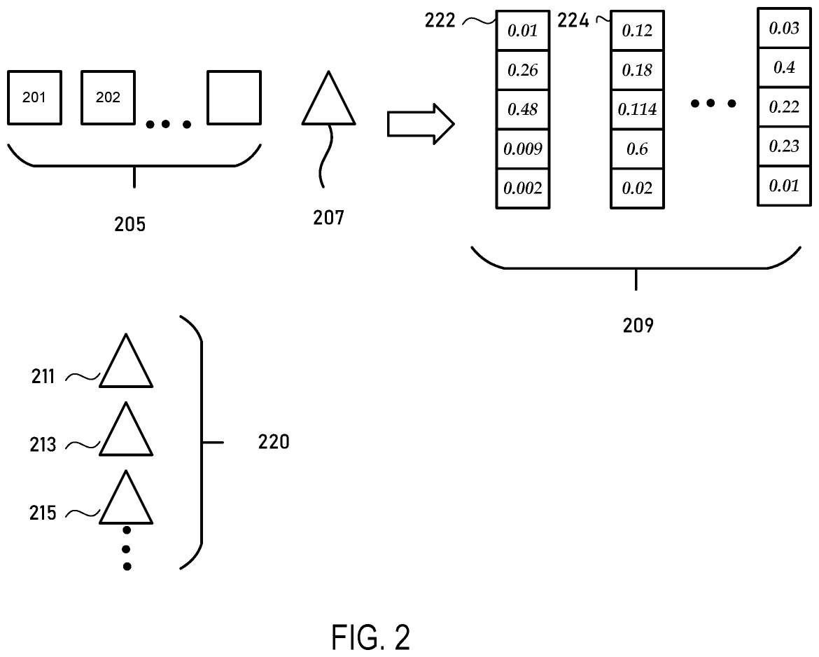

Referring to FIG. 2, example inputs to a machine learning model and example outputs for determining events to monitor are shown. A user history 205 may be an event sequence that includes a number of events (e.g., event 201 and event 202) or actions associated with a user. The user history 205 may include each recorded event associated with the user until a present time.

The system 100 may use a set of query tokens 220 as seeds for a machine learning model. For a given user, each query token may be appended to the user's history. In one example the query tokens may be different transaction events that a user could engage in. In one example shown in FIG. 2, the query token 207 is appended to the user history 205. The user history 205 with the appended query token 207 may be input into a machine learning model such as a large language model (e.g., or any machine learning model described below in connection with FIG. 3). The machine learning model may have been trained to generate probabilities of future events based on an event sequence (e.g., the user history 205).

The machine learning model may use the user history 205 and the appended query token 207 to generate probabilities of future events 209. The system 100 may generate multiple sets of probabilities for the future events 209. For example, probability set 222 may include the probabilities of each possible event occurring at a first-time step, and probability set 224 may include the probabilities of each possible event occurring at a second time step.

The system 100 may generate probabilities for each combination of user history 205 and a query token from the set of query tokens 220. For example, the system 100 may generate a set of probabilities of future events for each of query token 211 and user history 205, query token 213 and user history 205, query token 215 and user history 205 and so on. In this way, system 100 may generate a set of probabilities for each query token in the set of query tokens 220.

The system 100 may use the sets of probabilities to determine an average probability of a target event occurring given a query token. For example, a target event may be a user charging off (e.g., a bank needing to cancel credit card debt due to the user's inability to pay), the user submitting a fraud claim, or a variety of other events. The system 100 may sort the query tokens based on each query token's corresponding probability of the target event occurring. For example, the system 100 may determine a first average probability that the target event occurs in the set of probabilities associated with query token 211, a second average probability that the target event occurs in the set of probabilities associated with query token 213, and so on for each query token in the set of query tokens. The system 100 may determine a threshold number (e.g., three, five, etc.) of query tokens associated with the highest probability of the target event occurring. For example, the system 100 may sort the query tokens by average probability of target event and choose the top three query tokens, five query tokens, etc.

The system 100 may cause a monitoring system to monitor events for the determined threshold number of query tokens. For example, if a query token indicated an event of spending more than $100 at a jewelry store, the system 100 may cause a monitoring system (e.g., the server 108) to monitor for that event. If the event occurs, the system 100 may flag the event for review or may generate an alert message associated with the event.

The system 100 may determine the events to monitor as a batch process. The events to monitor may be updated for a given time period. For example, the system 100 may determine the events to monitor every day for one or more users. In this example, the user's history may include all events associated with the user (e.g., all events stored in the database 106) until the batch process begins. For example, each day, the events for monitoring may be determined based on any events that occurred the preceding day and any other previous day.

FIG. 3 shows illustrative components for a system 300 used for training machine learning models or using machine learning models (e.g., to determine an event for monitoring, predict probabilities of future events, or perform any other action described in connection with FIGS. 1-4), in accordance with one or more embodiments. The components shown in system 300 may be used to perform any of the functionality described above in connection with FIG. 1. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, mobile devices, and/or any device or system described in connection with FIGS. 1-2 and 4. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., data related to events, probabilities, or any other data described in connection with FIGS. 1-4).

Additionally, as mobile device 322 and user terminal 324 are shown as a touchscreen smartphone and a personal computer, respectively, these displays also act as user input interfaces. It should be noted that in some embodiments, the devices may have neither user input interfaces nor displays, and may instead receive and display content using another device (e.g., a dedicated display device, such as a computer screen, and/or a dedicated input device, such as a remote control, mouse, voice input, etc.). Additionally, the devices in system 300 may run an application (or another suitable program). The application may cause the processors and/or control circuitry to perform operations related to training machine learning models or using machine learning models (e.g., to determine an event for monitoring, predict probabilities of future events, or perform any other action described in connection with FIGS. 1-4).

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or Long-Term Evolution (LTE) network), a cable network, a public switched telephone network, or other types of communications networks or combinations of communications networks. Communication paths 328, 330, and 332 may separately or together include one or more communication paths, such as a satellite path, a fiber-optic path, a cable path, a path that supports Internet communications (e.g., IPTV), free-space connections (e.g., for broadcast or other wireless signals), or any other suitable wired or wireless communication path or combination of such paths. The computing devices may include additional communication paths linking a plurality of hardware, software, and/or firmware components operating together. For example, the computing devices may be implemented by a cloud of computing platforms operating together as the computing devices. Cloud components 310 may include the event system 102 or any other device or component described in connection with FIG. 1.

Cloud components 310 may include model 302, which may be a machine learning model, artificial intelligence model, etc. (which may be collectively referred to herein as “models”). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or other reference feedback information). For example, the system may receive a first labeled feature input, where the first labeled feature input is labeled with a known prediction for the first labeled feature input. The system may then train the first machine learning model to classify the first labeled feature input with the known prediction (e.g., to determine an event for monitoring, predict probabilities of future events, or perform any other action described in connection with FIGS. 1-4).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors be sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, backpropagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302.

In some embodiments, the model (e.g., model 302) may automatically perform actions based on outputs 306. In some embodiments, the model (e.g., model 302) may not perform any actions. The model (e.g., model 302) may be used to generate probabilities of future events or perform any other action described in connection with FIGS. 1-4.

System 300 also includes application programming interface (API) layer 350. API layer 350 may allow the system to generate summaries across different devices. In some embodiments, API layer 350 may be implemented on mobile device 322 or user terminal 324. Alternatively, or additionally, API layer 350 may reside on one or more of cloud components 310. API layer 350 (which may be a representational state transfer (REST) or web services API layer) may provide a decoupled interface to data and/or functionality of one or more applications. API layer 350 may provide a common, language-agnostic way of interacting with an application. Web services APIs offer a well-defined contract, called WSDL, that describes the services in terms of the API's operations and the data types used to exchange information. REST APIs do not typically have this contract; instead, they are documented with client libraries for most common languages, including Ruby, Java, PHP, and JavaScript. Simple Object Access Protocol (SOAP) web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful web services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: front-end layer and back-end layer, where microservices reside. In this kind of architecture, the role of the API layer 350 may provide integration between front-end and back-end layers. In such cases, API layer 350 may use RESTful APIs (exposition to front-end or even communication between microservices). API layer 350 may use AMQP (e.g., Kafka, RabbitMQ, etc.). API layer 350 may employ incipient usage of new communications protocols such as gRPC, Thrift, etc.

In some embodiments, the system architecture may use an open API approach. In such cases, API layer 350 may use commercial or open source API platforms and their modules. API layer 350 may use a developer portal. API layer 350 may use strong security constraints applying web application firewall (WAF) and distributed denial-of-service (DDoS) protection, and API layer 350 may use RESTful APIs as standard for external integration.

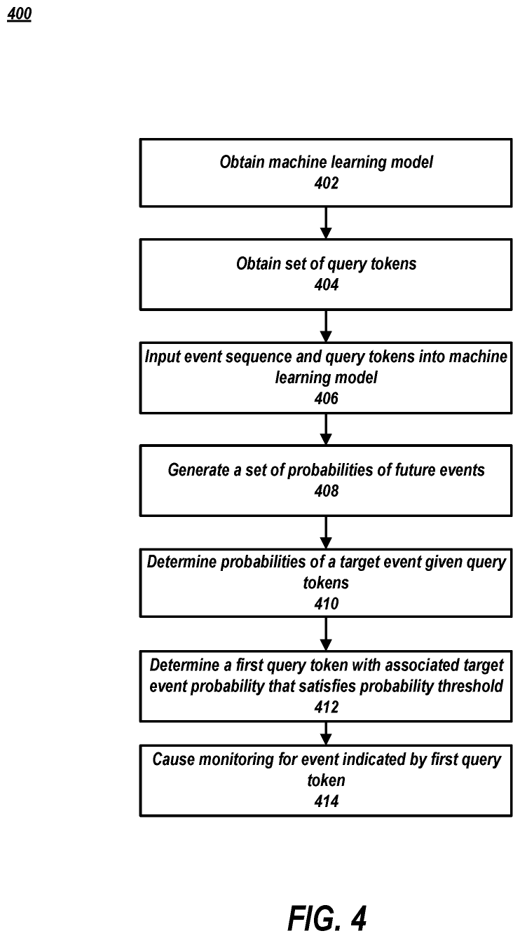

FIG. 4 shows a flowchart of the steps involved in using machine learning and event sequences to determine target event probabilities, in accordance with one or more embodiments. Although described as being performed by a computing system, one or more actions described in connection with process 400 of FIG. 4 may be performed by one or more devices shown in FIGS. 1-3. The processing operations presented below are intended to be illustrative and non-limiting. In some embodiments, for example, the method may be accomplished with one or more additional operations not described, or without one or more of the operations discussed. Additionally, the order in which the processing operations of the methods are illustrated (and described below) is not intended to be limiting.

At step 402, the computing system may obtain a machine learning model. The machine learning model may be a large language model (LLM). A large language model may include a neural network with greater than a threshold number of parameters (e.g., greater than 1 billion parameters, greater than 1 trillion parameters, etc.). The large language model may have been trained using self-supervised learning. Alternatively, the machine learning model may be any model described in connection with FIG. 3. The machine learning model may have been trained to predict an event performed by a user. The machine learning model may have been trained using sequences of events (e.g., events in the order that they occurred). In some embodiments, a second event of the event sequences may indicate a probability that an earlier event included a cybersecurity incident, transaction fraud, or a variety of other issues. In some embodiments, the second of the event sequence may indicate a probability that a later event included a cybersecurity incident, transaction fraud, or a variety of other issues.

At step 404, the computing system may obtain a set of query tokens. As an example, each query token may indicate an event and may be used as a seed event for the machine learning model. For example, the machine learning model may generate output indicating future events or probabilities of future events that may occur in connection with the event indicated by the query token. Each query token of the set of query tokens may be of the same query token or event type. For example, each query token may correspond to a transaction event.

At step 406, the computing system may input an event sequence and one or more query tokens of the set of query tokens into the machine learning model. The event sequence may be input into the machine learning model multiple times or in batches. Each time the event sequence is input into the machine learning model, the event sequence may be appended with a different query token of the set of query tokens. This may enable the machine learning model to predict different probabilities of future events because each input will be different due to the different query tokens.

At step 408, the computing system may generate one or more sets of probabilities of future events. The computing system may generate one set of probabilities for each query token or for each query token and event sequence pair. For example, a first event sequence may include events associated with a first user. The computing system may generate one set of probabilities for each query token and first event sequence pairing. A set of probabilities may correspond to multiple predicted future events. For example, a first vector in the set of probabilities may include probabilities for every possible event at a first time step, and a second vector in the set of probabilities may include probabilities for every possible event at a second time step.

The computing system may repeat this process for additional users. For example, the computing system may additionally generate one set of probabilities for each query token and second event sequence pairing (e.g., the second event sequence corresponding to a second user). By doing so, the computing system may be able to use the probabilities to determine what events should be monitored for each user, as discussed in more detail below. By determining probabilities specific to each user, the computing system may be able to better identify the riskiest events or actions for each user and may thus be more efficient in monitoring. This is because the computing system may be able to focus monitoring for a few actions for each specific user. Further, the computing system may determine the actions that are riskiest in an offline batch process and store the events in a table. In this way, the online process can be performed much more quickly (e.g., with low-latency of less than 200 ms) because the system may simply compare events as they occur with the events that have been stored rather than perform computationally expensive machine learning classifications live.

At step 410, the computing system may determine probabilities of one or more target events. The computing system may use the sets of probabilities generated in step 408 to determine a probability (e.g., an average probability) of a target event occurring. The computing system may determine an average probability of the target event occurring over the next threshold number of time steps or threshold number of events with which the user is associated.

At step 412, the computing system may determine a first query token with an associated target event probability that satisfies a probability threshold. For example, the computing system may determine that the first query token has the highest average probability of the target event occurring, based on the sets of probabilities of future events that were generated for the first query token (e.g., when the first query token was appended onto an event sequence and input into the machine learning model).

At step 414, the computing system may cause monitoring for an event indicated by the first query token. The computing system may cause a monitoring system (e.g., the server 108) to monitor for the event indicated by the first query token. For example, the event indicated by the first query token may involve a transaction with a particular merchant, a late payment by the user toward paying off a credit card debt, or a variety of other events.

In some embodiments, the computing system may determine a top threshold number of query tokens with the highest probability of the target event for a given user. For example, the computing system may sort the query tokens by average probability of target event and select the top three query tokens. The events indicated by the top three query tokens may be monitored for. If an event indicated by one of the top three query tokens occurs, the computing system may generate an alert or message. The alert or message may reverse the event (e.g., if the event is a transaction or other reversible event). The alert or message may be sent to a second user so that the second user can review the event and take further action.

This process may be repeated for multiple users. For example, each user may have their own threshold number of events that are monitored due to the corresponding query tokens having a high probability (e.g., higher than a threshold) of a target event occurring.

In some embodiments, the computing system may generate probabilities of future events without the use of query tokens. The computing system may generate a set of probabilities to use for classifying one or more events. The events may be events in an event sequence that was used as input to generate the set of probabilities. The computing system may determine, based on the set of probabilities, that a target event has greater than a threshold probability of occurring. Based on the target event having greater than the threshold probability of occurring, the computing system may generate a first classification for a historical event in the event sequence.

The computing system may generate a set of probabilities of future events based on a first event sequence. The first event sequence may be input into a machine learning model (e.g., a large language model or a model described in connection with FIG. 3). The first event sequence may be input into the machine learning model without a query token appended. The computing system may determine, based on the set of probabilities of future events, that a target event has greater than a threshold probability of occurring. For example, the target event may be a fraud claim made by a user (e.g., via an application). A fraud claim may indicate that one of the events in the first event sequence was a fraudulent transaction. If the machine learning model predicts future events that have high probability (e.g., higher than a threshold) of a fraud claim, it may indicate that one of the events in the sequence was fraudulent. Thus, based on the target event of a fraud claim having greater than the threshold probability of occurring, the computing system may generate a classification indicating that one or more of the events in the first event sequence was a fraudulent transaction.

As an additional example, the computing system may use an event sequence and the machine learning model to try to predict whether a user will have a charge off within the next eighteen months. The computing system may use the machine learning model to generate probabilities of future events for the event sequence and may look for the target event of becoming past due on credit card payoffs. In this example, there may be a charge off if the user is past due for more than eight months in a row. If the computing system determines that an average probability of becoming past due on credit card payoffs is greater than the threshold probability, the computing system may classify one or more events in the event sequence as a charge off event.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims that follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method comprising: obtaining a machine learning model trained to predict an event, the machine learning model having been trained on a dataset comprising event sequences; obtaining a set of query tokens, wherein each query token of the set of query tokens is usable as a seed event for the machine learning model; based on inputting an event sequence and the set of query tokens into the machine learning model, generating, for each pair of a set of pairs of the event sequence and a respective query token of the set of query tokens, a set of probabilities of future events; determining a first query token of the set of query tokens, wherein the first query token is associated with a probability of a target event that satisfies a threshold probability; and, based on the first query token being associated with the probability of the target event, marking an event associated with the first query token for monitoring.
2. The method of the preceding embodiment, further comprising: inputting an event sequence and the set of query tokens into the machine learning model, wherein the event sequence is input into the machine learning model multiple times, each time appended with a different query token of the set of query tokens.
3. The method of any of the preceding embodiments, wherein determining the first query token comprises: sorting the set of query tokens based on corresponding probabilities of the target event, wherein the first query token in the sorted set of query tokens is associated with a higher probability of the target event occurring than a second query token; and based on the sorting, determining the first query token.
4. The method of any of the preceding embodiments, further comprising: generating, based on the set of probabilities and the set of query tokens, monitoring rules for events; and causing a computing system to monitor based on the monitoring rules.
5. The method of any of the preceding embodiments, further comprising: generating a user interface comprising an indication of the first query token and the event sequence; and causing display of the user interface.
6. The method of any of the preceding embodiments, further comprising: determining, based on the set of probabilities of future events, that a target event has greater than a threshold probability of occurring; and based on the target event having greater than the threshold probability of occurring, generating a first classification for a historical event in the event sequence.
7. The method of any of the preceding embodiments, further comprising: based on identifying a second user having a second event sequence that matches a portion of the event sequence, storing an indication of the historical event, wherein the portion of the event sequences does not include the historical event; and based on the second user performing an event that matches the historical event, generating an alert message.
8. The method of any of the preceding embodiments, wherein each query token of the set of query tokens is usable as a seed event for the machine learning model.
9. The method of any of the preceding embodiments, wherein a second event of the event sequences indicates a probability that an earlier first event comprised a cybersecurity incident.
10. The method of any of the preceding embodiments, further comprising: determining, for each query token in the set of query tokens and based on the set of probabilities of future events, a probability of a target event.
11. A method comprising: obtaining a machine learning model trained to predict an event, the machine learning model having been trained on a dataset comprising event sequences; obtaining a first event sequence comprising an indication of events that a user has previously participated in; based on inputting the first event sequence into the machine learning model, generating a set of probabilities of future events; determining, based on the set of probabilities of future events, that a target event has greater than a threshold probability of occurring; and based on the target event having greater than the threshold probability of occurring, determining a first classification for a historical event in the first event sequence, wherein the first classification corresponds to the target event.
12. The method of any of the preceding embodiments, further comprising: based on generating the first classification for the historical event, identifying a second user having a second event sequence that matches the first event sequence; and based on the first event sequence matching the second event sequence, classifying a portion of the second event sequence with the first classification.
13. The method of any of the preceding embodiments, further comprising: based on identifying a second user having a second event sequence that matches a portion of the first event sequence, marking the historical event, wherein the portion of the first event sequence does not include the historical event; and based on the second user performing an event that matches the historical event, generating an alert message.
14. The method of any of the preceding embodiments, further comprising: generating a user interface comprising an indication of the first event sequence, historical event, and first classification; and causing display of the user interface.
15. One or more non-transitory machine-readable media storing instructions that, when executed by a data processing apparatus, cause the data processing apparatus to perform operations comprising those of any of embodiments 1-14.
16. A system comprising one or more processors; and memory storing instructions that, when executed by the processors, cause the processors to effectuate operations comprising those of any of embodiments 1-14.
17. A system comprising means for performing any of embodiments 1-14.

What is claimed is:

1. A system for determining events for monitoring for cyber security incidents by using a large language model to simulate future events and identifying alert-worthy events based on the simulations, the system comprising:
one or more processors programmed with instructions that, when executed by the one or more processors, cause operations comprising:
obtaining a large language model trained to predict an event performed by a user, the large language model having been trained on a dataset comprising event sequences, wherein a second event of the event sequences indicates a probability that an earlier first event comprised a cybersecurity incident;
obtaining a set of query tokens, wherein each query token of the set of query tokens is usable as a seed event for the large language model, and wherein each query token of the set of query tokens is of the same query token type;
inputting an event sequence and the set of query tokens into the large language model, wherein the event sequence is input into the large language model multiple times, each time appended with a different query token of the set of query tokens;
in response to inputting the event sequence and the set of query tokens into the large language model, generating, for each pair of a set of pairs of the event sequence and a respective query token of the set of query tokens, a set of probabilities of future events;
determining, for each query token in the set of query tokens and based on the set of probabilities of future events, a given probability of a target event;
determining a first query token of the set of query tokens, wherein the first query token is associated with a first probability of the target event that satisfies a threshold probability; and
based on the first query token being associated with the first probability of the target event, marking a first event associated with the first query token for monitoring.

2. A method comprising:
obtaining a machine learning model trained to predict an event, the machine learning model having been trained on a dataset comprising event sequences;
obtaining a set of query tokens, wherein each query token of the set of query tokens is usable as a seed event for the machine learning model;
inputting an event sequence and the set of query tokens into the machine learning model to generate, for each combination of a set of combinations of the event sequence and a respective query token of the set of query tokens, a set of probabilities of future events;
determining a first query token of the set of query tokens, wherein the first query token is associated with a first probability of a target event that satisfies a threshold probability; and
marking, based on the first query token being associated with the first probability of the target event, a first event associated with the first query token for monitoring.

3. The method of claim 2, wherein inputting the event sequence and the set of query tokens into the machine learning model comprises inputting the event sequence into the machine learning model multiple times, the event sequence being inputted into the machine learning model with a different query token of the set of query tokens each time of the multiple times.

4. The method of claim 2, wherein determining the first query token comprises:
sorting the set of query tokens based on corresponding probabilities of the target event, wherein the first query token in the sorted set of query tokens is associated with a higher probability of the target event occurring than a second query token; and
determining, based on the sorting, the first query token.

5. The method of claim 2, further comprising:
generating, based on the set of probabilities and the set of query tokens, monitoring rules for events; and
causing a computing system to monitor based on the monitoring rules.

6. The method of claim 2, further comprising:
generating a user interface comprising an indication of the first query token and the event sequence; and
causing display of the user interface.

7. The method of claim 2, further comprising:
determining, based on the set of probabilities of future events, that a target event has greater than a threshold probability of occurring; and
based on the target event having greater than the threshold probability of occurring, generating a first classification for a historical event in the event sequence.

8. The method of claim 7, further comprising:
based on identifying a second user having a second event sequence that matches a portion of the event sequence, storing an indication of the historical event, wherein the portion of the event sequences does not include the historical event; and
based on the second user performing an event that matches the historical event, generating an alert message.

9. The method of claim 2, wherein each query token of the set of query tokens is usable as a seed event for the machine learning model.

10. The method of claim 2, wherein a second event of the event sequences indicates a probability that an earlier first event comprised a cybersecurity incident.

11. The method of claim 2, further comprising:
determining, for each query token in the set of query tokens and based on the set of probabilities of future events, a given probability of a target event.

12. One or more non-transitory computer-readable media comprising instructions that, when executed by one or more processors, cause operations comprising:
obtaining a machine learning model trained to predict an event, the machine learning model having been trained on a dataset comprising event sequences;
obtaining a first event sequence comprising an indication of events in which a user has previously participated;
generating, based on inputting the first event sequence into the machine learning model, a set of probabilities of future events;
determining, based on the set of probabilities of future events, that a target event has greater than a threshold probability of occurring; and
determining, based on the target event having greater than the threshold probability of occurring, a first classification for a historical event in the first event sequence, wherein the first classification corresponds to the target event.

13. The media of claim 12, the operations further comprising:
identifying, based on the first classification for the historical event, a second user having a second event sequence that matches the first event sequence; and
classifying, based on the first event sequence matching the second event sequence, a portion of the second event sequence with the first classification.

14. The media of claim 12, the operations further comprising:
based on identifying a second user having a second event sequence that matches a portion of the first event sequence, marking the historical event, wherein the portion of the first event sequence does not include the historical event; and
based on the second user performing an event that matches the historical event, generating an alert message.

15. The media of claim 12, the operations further comprising:
generating a user interface comprising an indication of the first event sequence, historical event, and first classification; and
causing display of the user interface.

16. The media of claim 12, the operations further comprising:
determining a first query token of a set of query tokens, wherein the first query token is associated with a first probability of a target event that satisfies a threshold probability; and
marking, based on the first query token being associated with the first probability of the target event, a first event associated with the first query token for monitoring.

17. The media of claim 16, wherein determining the first query token comprises:
sorting the set of query tokens based on corresponding probabilities of the target event, wherein the first query token in the sorted set of query tokens is associated with a higher probability of the target event occurring than a second query token; and
determining, based on the sorting, the first query token.

18. The media of claim 16, wherein each query token of the set of query tokens is usable as a seed event for the machine learning model.

19. The media of claim 16, wherein a second event of the event sequences indicates a probability that an earlier first event comprised a cybersecurity incident.

20. The media of claim 16, the operations further comprising:
determining, for each query token in the set of query tokens and based on the set of probabilities of future events, a given probability of a target event.
